(19) United States
(12) Patent Application Publication
(10) Pub. No.: US 2022/0322146 A1
(43) Pub. Date: Oct. 6, 2022

(54) METHOD AND TRANSMISSION DEVICE FOR MOBILE RADIO TRANSMISSION OF MEASURED DATA

(71) Applicant: Bender GmbH & Co. KG, Gruenberg (DE)

(72) Inventors: Michael Sebekow, Staufenberg (DE); Markus Kremer, Gruenberg (DE)

(21) Appl. No.: 17/713,320

(22) Filed: Apr. 5, 2022

(30) Foreign Application Priority Data
Apr. 6, 2021 (DE) 10 2021 108 517.9

(51) Int. Cl. H04W 28/18; H04W 48/16; H04W 72/04; H04L 69/22

(52) U.S. Cl. CPC H04W 28/18; H04W 48/16; H04W 72/0426; H04L 69/22

(57) ABSTRACT

The invention relates to a method and a transmission device for mobile radio transmission of measured data, the transmission device including a transmitter and a receiver which implement a Wi-Fi transmission process according to communications standard IEEE 802.11. The transmitter has a Wi-Fi module which is configured for allocating a vendor specific element of a beacon frame with measured data and for transmitting the measured-data beacon frame. The receiver includes a different Wi-Fi module which operates in a promiscuous mode and is configured for receiving and recording all beacon frames; for filtering the measured-data beacon frame; and for assigning the measured-data beacon frame to the corresponding transmitter.

This application claims priority to German Patent Application No. 10 2021 108 517.9 filed on Apr. 6, 2021, the disclosure of which is incorporated herein by reference.

### TECHNICAL FIELD

The invention relates to a method for mobile radio transmission of measured data between a transmitter and a receiver, based on a Wi-Fi transmission method according to communications standard IEEE 802.11, and to a transmission device which consists of a transmitter and a receiver and is configured for mobile radio transmission of measured data, the transmitter and the receiver implementing a Wi-Fi transmission method according to communications standard IEEE 802.11.

### BACKGROUND

Beside data transmission methods which, such as the Ethernet, control the access to wired transmission media for stationary data sources and data sinks, wireless radio transmission techniques are gaining on importance for communication between mobile transmitters and mobile receivers. Mobile radio standards, such as 5G or, in particular for local applications, Wi-Fi transmission methods according to communications standard IEEE 802.11 (WLAN), can serve as possible standards.

In the state of the art, Specification U.S. Pat. No. 10,285,127 B2 discloses a wireless communication device based on the Wi-Fi communications standard IEEE 802.11, status data of the communication terminal end devices being transmitted by means of a vendor-specific frame specified in Wi-Fi communications standard 802.11 before and after a dial-up.

For industrial applications, the measured data generated by the transmitters (sensors) are typically embedded as user data in the data stream on the application-oriented protocol layers of the specified communications system and are sent by means of transmission methods, which are adapted to the transmission channel, in order to be merged and processed at a central location.

In this context, the fairly intricate protocol-specific integration of the measured data in the application-oriented layers and an often too slow connection establishment between the transmitter and the receiver prove to be disadvantageous. In particular for mobile applications, where the transmitter and the receiver are moved in relation to one another under non-stationary propagation conditions and moreover the communication duration can be temporally limited, a complex connection establishment proves cumbersome.

### SUMMARY

The object of the invention at hand is therefore to propose a method and a device for transmitting measured data between the transmitter and the receiver, quickly and centrally registering measured data between the transmitter and the receiver being possible.

This object is attained by a method for mobile radio transmission of measured data, based on a Wi-Fi transmission method according to communications standard IEEE 802.11, by allocating a vendor specific element of a beacon frame with the measured data in the transmitter equipped with a Wi-Fi module and sending this measured-data beacon frame; receiving and recording all beacon frames in the receiver equipped with a different Wi-Fi module and operating in a promiscuous mode; and filtering the measured-data beacon frame and assigning it to the corresponding transmitter in the receiver.

The fundamental idea of the invention at hand is based on transmitting the measured data in data packets as content of specified, optional vendor specific elements within a specified beacon frame format of the used Wi-Fi transmission method according to communications standard IEEE 802.11.

When transmitting data between the transmitter and the receiver, it is thus presumed that beacon frames specified in the Wi-Fi transmission method are transmitted. The beacon frames represent a specific type (subtype) of a specified Wi-Fi MAC layer management frame. Optionally, these beacon frames in turn can contain vendor specific information elements (vendor specific elements) which can be stuffed with application-specific data (beacon stuffing). The vendor specific elements can thus be allocated in the transmitter with measured data as application-specific data and can be sent as measured-data beacon frames. Preferably, maximally two vendor specific elements per beacon frame are allocated with the application-specific measured data.

The receiver is also equipped with a Wi-Fi module which operates in a promiscuous mode according to the specified Wi-Fi transmission method and is configured for receiving and recording all beacon frames. As the Wi-Fi module in the receiver operates in the promiscuous mode, all of the received data traffic is read. The measured-data beacon frames are filtered from the received beacon frames and assigned to the corresponding transmitter.

In another embodiment, the data integrity of the measured data is verified by means of a digital signature scheme.

The measured data are transmitted in clear text as content of the vendor specific element, albeit signed with a digital signature in order to ensure data integrity.

Furthermore, the authenticity of the transmitter is verified by means of an asymmetric cryptography system.

To ensure that the transmitter is a trustworthy device, the receiver can unambiguously authenticate the device authorship, and consequently the transmitter of the measured data, using a public key (public-key authentication), provided an Internet connection is available.

The object of the invention is further attained by a transmission device for mobile radio transmission of measured data, the transmission device consisting of a transmitter and a receiver which implement a Wi-Fi transmission method according to communications standard IEEE 802.11, the transmitter comprising a Wi-Fi module which is configured for allocating a vendor specific element of a beacon frame with the measured data and for sending the measured-data beacon frame and the receiver comprising a different Wi-Fi module which operates in a promiscuous mode and is configured for receiving and recording all beacon frames; for filtering the measured-data beacon frame; and for assigning the measured-data beacon frame to the corresponding transmitter.

The claimed features of the transmission device according to the invention implement the corresponding method steps of the method according to the invention. Thus, the advantages pertaining to the method apply to the transmission device in the same manner.

### BRIEF DESCRIPTION OF THE DRAWINGS

Further advantageous embodiments are derived from the following description and drawings, which describe a preferred embodiment using examples.

FIG. 1 shows an application of the transmission device according to the invention,

FIG. 2 shows a frame structure of a management frame,

FIG. 3 shows a frame structure of a beacon frame, and

FIG. 4 shows a frame structure of a vendor specific element.

### DETAILED DESCRIPTION

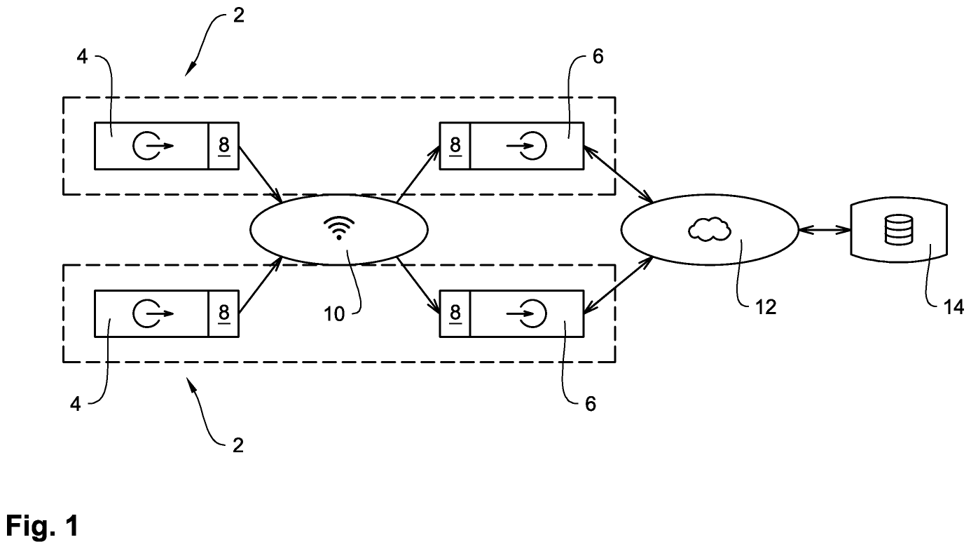

FIG. 1 is a schematic view of an application of the transmission device 2 according to the invention.

Transmission device 2 consists of a transmitter 4 and a receiver 6. Both transmitter 4 and receiver 6 each comprise a Wi-Fi module 8.

The transmitter is preferably configured as a sensor for the measured registration of physical variables or, in general, for the registration of process data.

In a first constellation (upper arrangement in FIG. 1), the transmitter is stationary, whereas receiver 6 is a mobile receiver 6. In this case, the measured data is to be registered, for example, if mobile receiver 6, for example embodied as a tablet with application software, moves past stationary transmitter 4. For this constellation, a radio connection is only possible for a limited amount of time.

In a second constellation (lower arrangement in FIG. 1), mobile transmitter 4 communicates with a stationary receiver 6. In this case, mobile transmitter 4 moves past a stationary receiver 6 for a limited amount of time.

A combination of both application cases with a mobile transmitter 4 and a mobile receiver 6 is also possible.

Via Wi-Fi module 8, transmitter 4 and receiver 6 communicate based on Wi-Fi transmission method 10.

In addition, receiver 6 also has an Internet connection 12 which permits access to a databank 14.

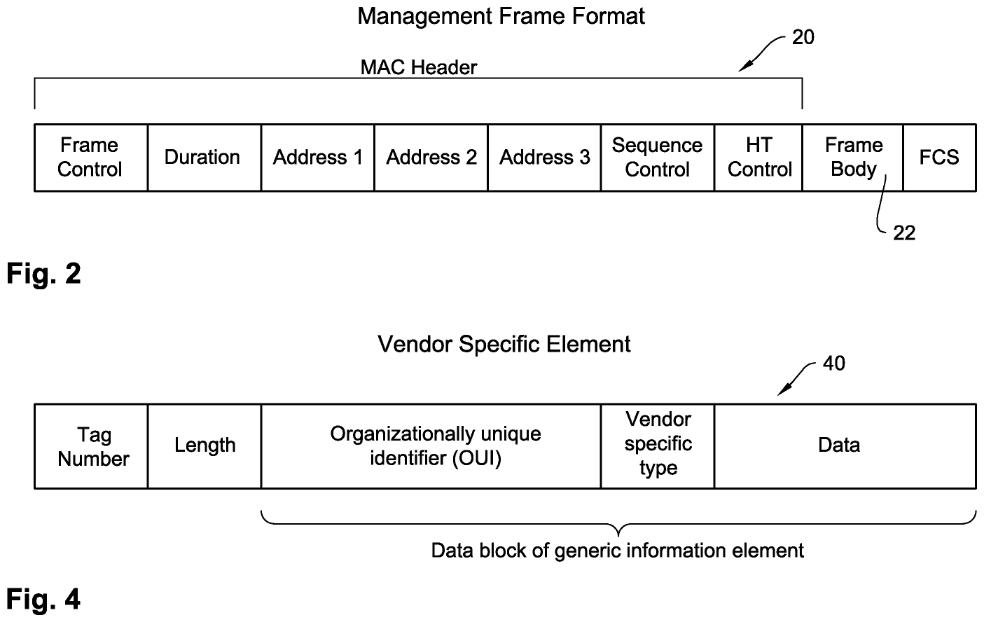

FIG. 2 shows the frame structure of a management frame format 20.

Wi-Fi MAC layer management frame 20 is tasked with making a Wi-Fi station (as an access point) visible in near vicinity.

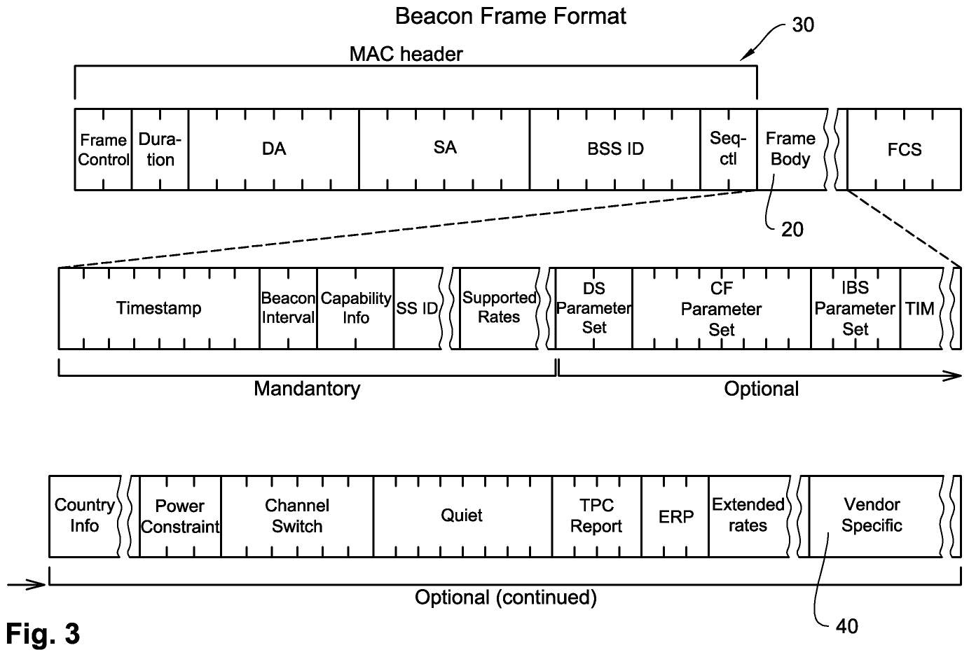

A subtype of management frame 20 of the type beacon frame 30 is shown with its frame structure in FIG. 3.

The subtype beacon frame 30 has a variable data field frame body 22 which in turn has optional data fields of variable length, namely vendor specific elements 40.

Such a vendor specific element 40 (vendor-specific information elements) is shown in FIG. 4.

These vendor-specific information elements 40 can be allocated with application-specific data. In the present instance, the measured data registered by transmitter 4 is stored in vendor specific element 40. Up to two vendor specific elements 40 can be used per beacon frame 30. Each vendor specific element 40 can contain up to 252 bytes of data. Ergo, two vendor specific elements 40 permit a maximum storage of 504 bytes. In this instance, one vendor specific element 40 is provided for the measured data and the other is provided for security-relevant data.

1. A method for mobile radio transmission of measured data between a transmitter (4) and a receiver (6), based on a Wi-Fi transmission method (10) according to communications standard IEEE 802.11, the method comprising the following steps:
allocating a vendor specific element (40) of a beacon frame (30) with the measured data in the transmitter (4) equipped with a Wi-Fi module (8) and sending this measured-data beacon frame (30),
receiving and recording all beacon frames (30) in the receiver (6) equipped with a different Wi-Fi module (8) and operating in a promiscuous mode, and
filtering the measured-data beacon frame (30) and assigning it to the corresponding transmitter (4) in the receiver (6).

2. The method according to claim 1,
characterized in that
the data integrity of the measured data is verified by means of a digital signature scheme.

3. The method according to claim 1,
characterized in that
the authenticity of the transmitter (4) is verified by means of an asymmetric cryptography system.

4. A transmission device (2) for mobile radio transmission of measured data, the transmission device (2) comprising a transmitter (4) and a receiver (6) which implement a Wi-Fi transmission method (10) according to communications standard IEEE 802.11,
the transmitter (4) comprising a Wi-Fi module (8) which is configured for allocating a vendor specific element (40) of a beacon frame (30) with the measured data and for sending the measured-data beacon frame (30),
the receiver (6) comprising a different Wi-Fi module (8) which operates in a promiscuous mode and is configured for receiving and recording all beacon frames (30); for filtering the measured-data beacon frame (30); and for assigning the measured-data beacon frame (30) to the corresponding transmitter (4).

5. The transmission device according to claim 4,
characterized by
a configuration for verifying the data integrity of the measured data by means of a digital signature scheme.

6. The transmission device according to claim 4,
characterized by
a configuration for verifying the authenticity of the transmitter (4) by means of an asymmetric cryptography system.
